(19) United States
(12) Patent Application Publication
(10) Pub. No.: US 2024/0320642 A1
(43) Pub. Date: Sep. 26, 2024

(54) Proactive and Real-Time Anomaly Identification and Resolution for Automated Teller Machines (ATMs)

(71) Applicant: Bank of America Corporation, Charlotte, NC (US)

(72) Inventors: Paul Mattison, Sherrills Ford, NC (US); David Smiddy, Chadds Ford, PA (US); Charles H. Gruesbeck, II, Mint Hill, NC (US); Kurt A. Loth, Concord, CA (US); Matthew E. Williams, Frisco, TX (US); Nathaniel Mckinnon, Richmond, VA (US); Melvin Gregory Nixon, Clover, SC (US); Frazier Smith, Elkton, MD (US); Nicholas F. Catalano, Phoenix, AZ (US); Aaron L. Buchanan, Mint Hill, NC (US); Frederick Louis Chinske, IV, Rockwall, TX (US)

(21) Appl. No.: 18/124,135

(22) Filed: Mar. 21, 2023

(51) Int. Cl. G06Q 20/10

(52) U.S. Cl. CPC G06Q 20/1085

(57) ABSTRACT

Aspects of the disclosure related to identifying and resolving anomalies associated with an ATM processing a check that has been deposited by a customer. The computing platform may receive a digital representation of the check that has been deposited. The computing platform may compare parameters associated with the check to expected parameters. The computing platform may generate a validation report comprising an anomaly, an event code associated with the anomaly, and an action to resolve the anomaly based on the event code. The computing platform may input results and feedback into a machine learning model to further refine the accuracy and reliability of the computing platform over time.

### BACKGROUND

Aspects of the disclosure relate to automated teller machine (ATM) (and/or other self-service kiosk) financial instrument processing and associated anomaly identification/resolution. In some instances, ATMs may be used to process financial instruments, such as checks, that have been deposited by an individual. Identification and resolution of anomalies may be time consuming (e.g., due to the high volume of checks that are processed by ATMs every day) and may be performed in an exclusively retroactive manner (e.g., detecting anomalies once they have already occurred and the check is processed). Accordingly, it may be advantageous to improve the process of identifying and resolving such anomalies, so as to provide proactive and real-time anomaly resolution for improved ATM security.

### SUMMARY

Aspects of the disclosure provide effective, scalable, and convenient technical solutions that address and overcome the technical problems associated with identifying and resolving ATM input anomalies. In accordance with one or more embodiments of the disclosure, a computing platform comprising at least one processor, a communication interface, and memory storing computer-readable instructions may train, using historical information, an anomaly resolution model, configured to generate a validation report that may include an anomaly, an event code associated with the anomaly, and an action to resolve the anomaly based on the event code. The computing platform may receive, from an automated teller machine (ATM), a digital check that may be a digital representation of a check that was received (e.g., physically received) by the ATM. The computing platform may extract first parameters associated with the digital check. The computing platform may input the first parameters into the anomaly resolution model to: 1) output a first anomaly and a first event code associated with the first anomaly, 2) determine a first action to resolve the first anomaly, and 3) generate a first validation report, where the first validation report may include the first anomaly, the first event code associated with the first anomaly, and the first action to resolve the first anomaly. The computing platform may generate, using the first validation report, one or more commands, that when executed by the ATM, may cause the ATM to execute the first action to resolve the first anomaly. The computing platform may send, to the ATM, the one or more commands, where sending the one or more commands may cause the ATM to execute the first action to resolve the first anomaly.

In one or more instances, the computing platform may send, to an enterprise user device, the first validation report and one or more commands directing the enterprise user device to display the first validation report, where sending the one or more commands directing the enterprise user device to display the validation report may cause the enterprise user device to display the validation report.

In one or more examples, the computing platform may receive, from the ATM, a second digital check that may be a digital representation of a second check that has been received by the ATM. The computing platform may extract second parameters associated with the second digital check. The computing platform may output, based on comparing values of the second parameters to expected values of the second parameters, a second anomaly and a second event code associated with the second anomaly. The computing platform may determine, based on the second anomaly and the second event code, a second action to resolve the second anomaly. The computing platform may generate one or more commands, that when executed by the ATM, may cause the ATM to execute the second action to resolve the second anomaly. The computing platform may send, to the ATM, the one or more commands, where sending the one or more commands may cause the ATM to execute the second action to resolve the second anomaly.

In one or more examples, the first parameters may include one or more of an insignia associated with the check, a name associated with the check, an address associated with the check, an account number associated with the check, a routing number associated with the check, a check number associated with the check, a dollar amount associated with the check, and a bank code associated with a financial institution issuing the check.

In one or more instances, the computing platform may include a data matrix that may be associated with the check and may contain an encoded representation of one or more parameters that may be dynamically configured based on a set of rules. In one or more examples, the set of rules may include one or more of a first rule of determining a combination of parameters based on a customer depositing the check, a second rule of determining a length of time to use the combination of parameters, a third rule of determining a frequency of changing the combination of parameters, and a fourth rule of configuring a random number generator to output a random number corresponding to the determining the combination of parameters.

In one or more instances, the first event code may be a numerical value. In one or more examples, the computing platform may compare the numerical value to a threshold. The computing platform may, based on identifying that the numerical value is greater than or equal to the threshold, select, as the first action, one or more of causing the ATM to be in a state of alert for future potential anomalies, recording a video feed associated with the ATM for a period of time, pausing an ability to use a pin code associated with an account that is associated with the check, placing a hold on processing the check at the ATM, cancelling processing of the check at the ATM, shutting down processing of future checks at the ATM for a period of time, or shutting down processing of future checks for a fleet of ATMs in a geographic region associated with the ATM.

In one or more instances, causing the ATM to be in a state of alert may cause the ATM to decrease a level of error tolerance associated with processing the digital check. In one or more examples, the anomaly resolution model may be refined based on the check, the first anomaly, the first event code associated with the first anomaly, and the first action to resolve the first anomaly. In one or more examples, the historical information may include historical checks, historical anomalies, historical event codes associated with corresponding historical anomalies, historical actions that resolved the corresponding historical anomalies, and historical validation reports.

In one or more instances, the anomaly resolution model may include one of a locally stored model at a backend server or a cloud based model. In one or more examples, the ATM may automatically execute the first action to resolve the first anomaly in real-time. In one or more instances, the computing platform may generate one or more commands, that when executed by a second ATM, may cause the second ATM to execute a second action based on the first action. The computing platform may send, to the second ATM, the one or more commands, where sending the one or more commands may cause the second ATM to execute the second action.

In one or more examples, the digital representation of the check may be in a grayscale format. In one or more instances, the digital representation of the check may be a digital image of the check.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for identifying and resolving ATM input anomalies in accordance with one or more aspects described herein;

FIGS. 2A-2E depict an illustrative event sequence for identifying and resolving ATM input anomalies in accordance with one or more aspects described herein;

FIG. 3 depicts an illustrative method for identifying and resolving ATM input anomalies in accordance with one or more aspects described herein; and

FIGS. 4-5 depict illustrative graphical user interfaces for identifying and resolving ATM input anomalies in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. In some instances, other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As a brief introduction to the concepts described further herein, one or more aspects of the disclosure relate to detecting and resolving anomalies when a self-service kiosk, such as an ATM, automated teller assistant (ATA), or the like, processes a financial instrument, such as, for example, a check, treasury note, or the like. ATMs may be used by customers to perform financial transactions. In today's environment, identification of unauthorized activity may occur downstream from the ATM and there may be limitations in the ability to identify characteristics of checks such as labels, insignias, pictures, and/or other features at the ATM that may allow for real-time blocking of the check from processing. In addition, check images may be sent after the transaction is complete which may also may prove as a barrier to real-time blocking.

Accordingly, it may be advantageous to speed up the processing of financial instruments using more robust systems with modern technologies, enabling the systems to identify labels, insignias and images, (and in some instances, perform a routing and/or account number comparison), to identify unauthorized activity and block processing at the ATM and/or downstream. Once a financial instrument, such as a check, is sent downstream, anomalies may be flagged by priority so that certain event codes may be prioritized for review. Technology may be enabled such as multi-protocol label switching (MPLS) for real-time processing downstream from the ATM, or advanced hardware capabilities may be leveraged to perform processing on the ATM. The system may have the capability to turn on and off at several customizable levels of the ATM fleet (i.e. State, Region, City, or machine level).

In some instances, a machine learning model, such as an anomaly resolution model may be trained to identify and resolve anomalies associated with an individual depositing a financial instrument at an ATM. For example, the anomaly resolution model may be trained to output a validation report that comprises an identified anomaly, an event code associated with the anomaly, and/or an action to the resolve the anomaly. These and other features are described in further detail below.

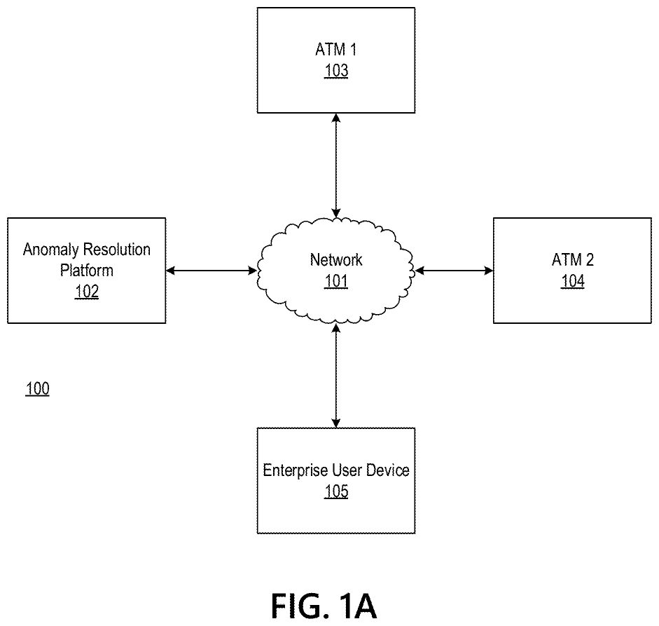

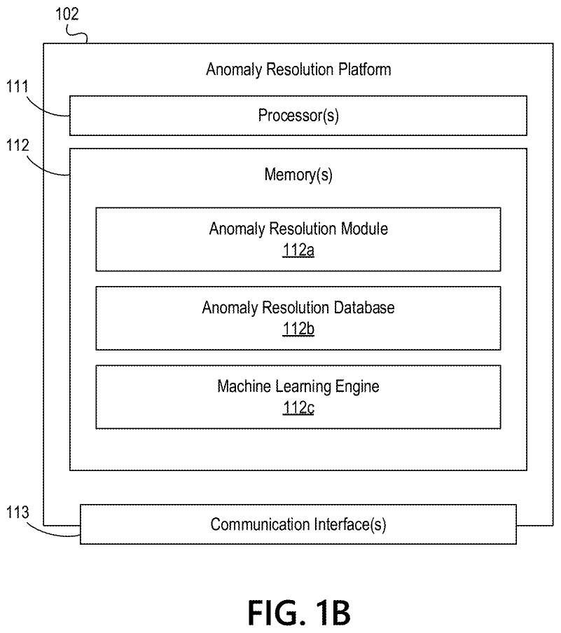

FIGS. 1A-1B depict an illustrative computing environment for identifying and resolving ATM input anomalies in accordance with one or more aspects described herein. Referring to FIG. 1A, computing environment 100 may include one or more computer systems. For example, computing environment 100 may include anomaly resolution platform 102, first ATM 103, second ATM 104, and enterprise user device 105.

As described further below, anomaly resolution platform 102 may be a computer system that includes one or more computing devices (e.g., servers, server blades, or the like) and/or other computer components (e.g., processors, memories, communication interfaces) that may be used to train, host, and/or otherwise refine an anomaly resolution model, which may be used to detect and resolve anomalies associated with an ATM processing a financial instrument (e.g., a check, treasury bill, bond, etc.) that has been received at an ATM. In these instances, an action may be determined to resolve an anomaly based on a corresponding event code.

In some instances, anomaly resolution platform 102 may be configured as a cloud storage system, in which anomaly resolution platform 102 may be a cloud computing model that stores information on the Internet through a cloud computing provider who manages and operates anomaly resolution platform 102 as a service. In some instances, anomaly resolution platform 102 may be local or non-cloud based storage, such as a backend server or database associated with an enterprise organization (e.g., a financial institution). In some instances, the anomaly resolution platform 102 may support cloud based storage. In some instances, anomaly resolution platform 102 may be configured to store information related to a check that has been processed, anomalies and corresponding event codes associated with the financial instrument, actions that resolved anomalies, and the like.

The first ATM 103 and/or second ATM 104 may be computing devices or systems configured to dispense funds, display account information, and/or otherwise facilitate transactions for a customer such as processing a recently deposited financial instrument. In some instances, anomaly resolution platform 102 may be located at either of the first ATM 103 and/or the second ATM 104, or may be located at a different physical location than the first ATM 103 and/or the second ATM 104. Although only two ATMs (first ATM 103 and second ATM 104) are shown, this is for illustrative purposes only, and any number of ATMs may be included in the environment 100 without departing from the scope of the disclosure.

Enterprise user device 105 may be and/or otherwise include a laptop computer, desktop computer, mobile device, tablet, smartphone, server, server blade, and/or other device that may be configured to receive and/or display a validation report (e.g., comprising an anomaly, an event code associated with the anomaly, and an action to resolve the anomaly) using one or more user interfaces (e.g., FIG. 5), on behalf of an enterprise organization, such as a financial institution. In some instances, the enterprise user device 105 may be a user device (i.e., a mobile phone) associated with a client of the financial institution. For example, the validation report may be sent to the client's user device if an anomaly associated with the processing of a financial instrument has been identified.

Computing environment 100 also may include one or more networks, which may interconnect anomaly resolution platform 102, first ATM 103, second ATM 104, and/or enterprise user device 105. For example, computing environment 100 may include a network 101 (which may interconnect, e.g., anomaly resolution platform 102, first ATM 103, second ATM 104, and/or enterprise user device 105).

In one or more arrangements, anomaly resolution platform 102, first ATM 103, second ATM 104, and/or enterprise user device 105 may be any type of computing device capable of sending and/or receiving requests and processing the requests accordingly. For example, anomaly resolution platform 102, first ATM 103, second ATM 104, enterprise user device 105, and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of anomaly resolution platform 102, first ATM 103, second ATM 104, and/or enterprise user device 105 may, in some instances, be special-purpose computing devices configured to perform specific functions.

Referring to FIG. 1B, anomaly resolution platform 102 may include one or more processors (e.g., processor 111), memory 112, and a communication interface (e.g., communication interface 113)). A data bus may interconnect the processor 111, memory 112, and communication interface 113. Communication interface 113 may be a network interface configured to support communication between anomaly resolution platform 102 and one or more networks (e.g., network 101, or the like). Communication interface 113 may be communicatively coupled to the processor(s) 111. The memory may include one or more program modules having instructions that when executed by processor(s) 111 cause anomaly resolution platform 102 to perform one or more functions described herein and/or one or more databases that may store and/or otherwise maintain information which may be used by such program modules and/or processor(s) 111. In some instances, the one or more program modules and/or databases may be stored by and/or maintained in different memory units of anomaly resolution platform 102 and/or by different computing devices that may form and/or otherwise make up anomaly resolution platform 102. For example, the memory may have, host, store, and/or include anomaly resolution module 112a, anomaly resolution database 112b, and/or machine learning engine 112c.

Anomaly resolution module 112a may have instructions that direct and/or cause anomaly resolution platform 102 to receive a digital representation of a financial instrument, such as, for example, a check that has been recently received by an ATM (e.g., at the first ATM 103), and to subsequently identify/resolve anomalies associated with the check accordingly, as discussed in greater detail below. Anomaly resolution database 112b may have instructions and/or data used by anomaly resolution module 112a, and/or anomaly resolution platform 102 to store information used by anomaly resolution module 112a and/or anomaly resolution platform 102 in identifying and resolving anomalies and/or performing other functions. Machine learning engine 112c may implement, refine, train, maintain, and/or otherwise host a machine learning or artificial intelligence (AI) model, such as an anomaly resolution model, that may be used to identify and resolve anomalies associated with the check, and/or other methods described herein.

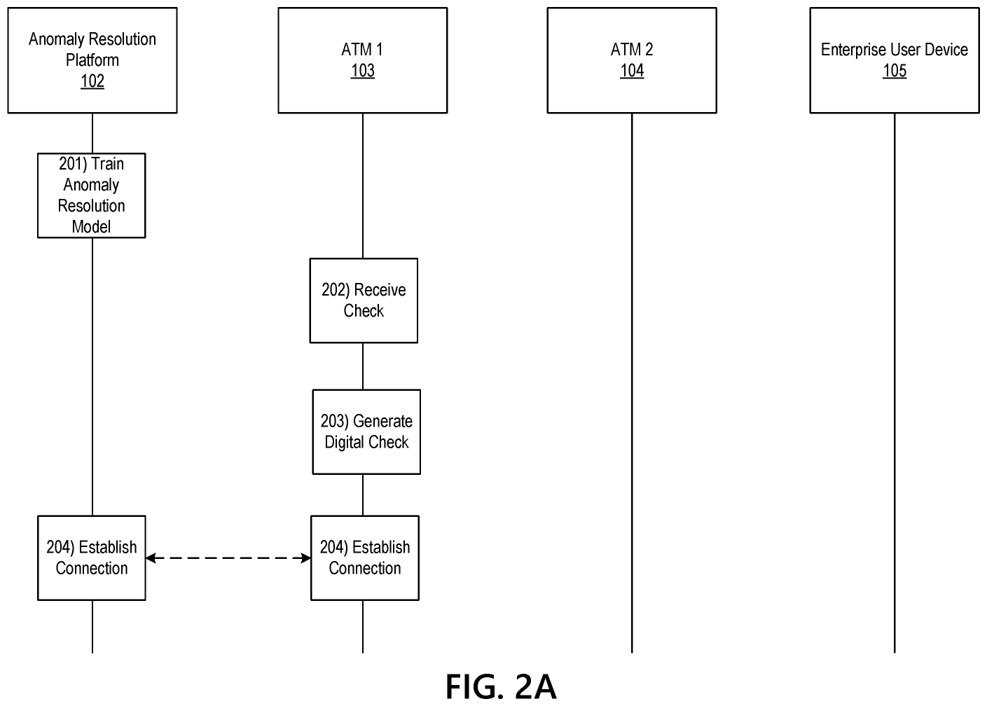

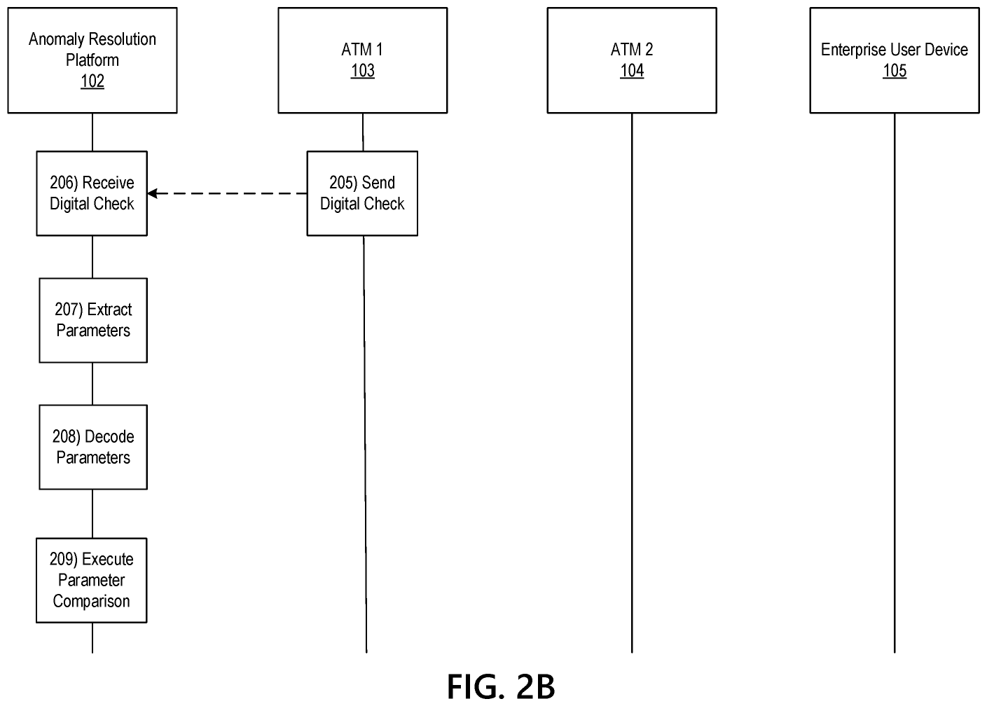

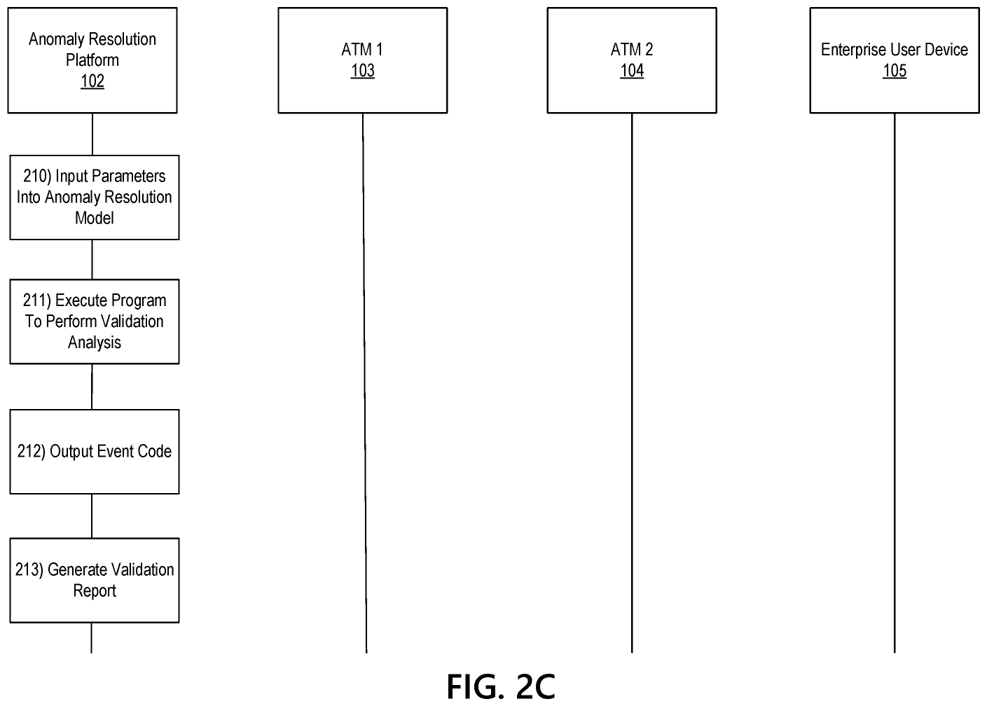

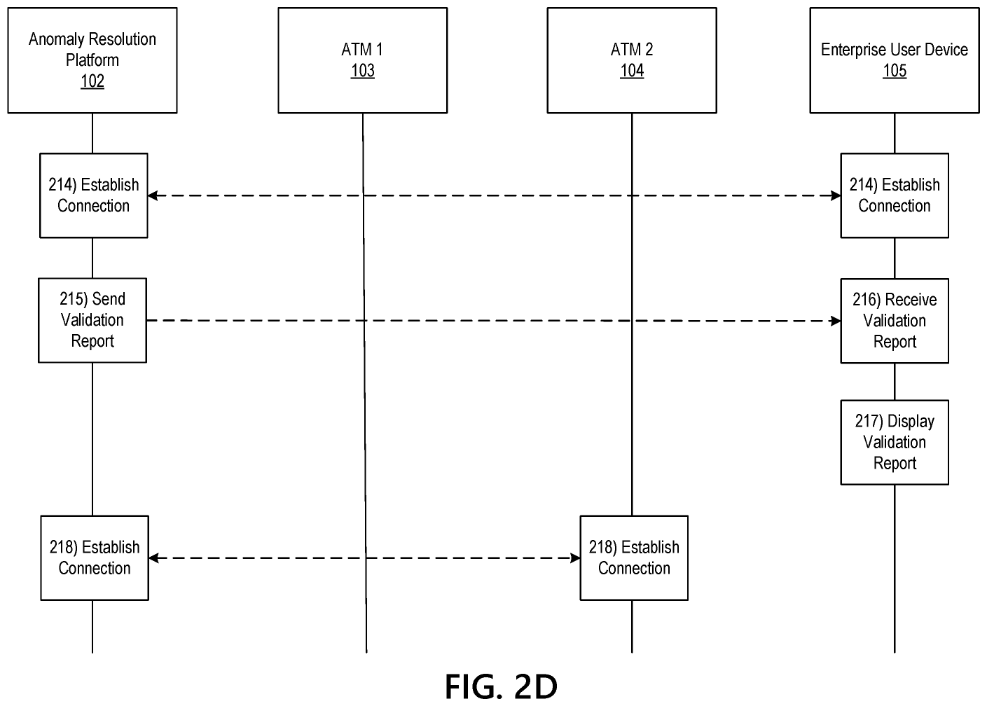

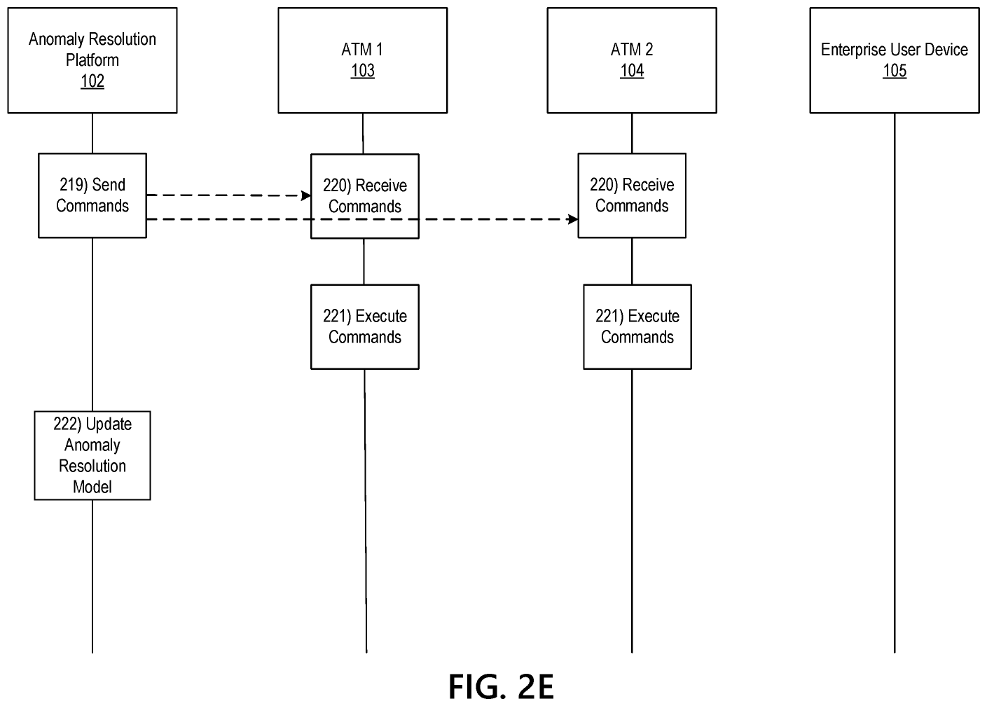

FIGS. 2A-2E depict an illustrative event sequence for identifying and resolving ATM input anomalies in accordance with one or more aspects described herein. Referring to FIG. 2A, at step 201, the anomaly resolution platform 102 may train the anomaly resolution model using historical information. In some instances, in training the anomaly resolution model, the anomaly resolution platform 102 may train a supervised learning model. For example, the anomaly resolution platform 102 may use historical ATM information (e.g., information including anomalies, event codes associated with the anomalies, actions to resolve the anomalies based on the event codes, and the like), which may be used to classify information and accurately predict outcomes with respect to anomaly identification and resolution. For example, an anomaly may be a mismatch between the value of a parameter associated with a financial instrument and the expected value of the parameter that corresponds to the parameter (e.g., a mismatch between a name and an expected name, a mismatch between an account number and an expected account number, and the like). Using labeled inputs and outputs, the anomaly resolution model may measure its accuracy and learn over time. For example, supervised learning techniques such as linear regression, classification, neural networking, and/or other supervised learning techniques may be used.

Additionally or alternatively, the anomaly resolution model may utilize unsupervised learning, in which unlabeled data may be input into the machine learning model. For example, unsupervised learning techniques such as k-means, gaussian mixture models, frequent pattern growth, and/or other unsupervised learning techniques may be used. In some instances, the machine learning model may be a combination of supervised and unsupervised learning. In doing so, the anomaly resolution platform 102 may dynamically and continuously update and/or otherwise refine the anomaly resolution model so as to increase accuracy of the machine learning model over time.

In some instances, the historical information may include historical checks that have been processed by an ATM, such as the first ATM 103 and/or the second ATM 104, historical anomalies associated with the historical checks, historical event codes associated with corresponding historical anomalies, historical actions that resolved corresponding historical anomalies, historical validation reports, and/or the like. The historical information may also be historical information about other types of financial instruments without departing from the scope of the disclosure. In doing so, the anomaly resolution platform 102 may train the anomaly resolution model to identify the anomalies and/or identify actions that may be performed by the anomaly resolution platform 102 in response to identifying particular anomalies.

At step 202, the first ATM 103 may receive a financial instrument, such as a check. Although the description below describes the process in relation to the identification and resolution of a check, the below steps could be described with respect to other financial instruments without departing from the scope of disclosure. In some instances, an individual may submit the check using a mobile user device associated with the individual, which may be received by the anomaly resolution platform 102.

For example, an individual, such as a customer, may deposit a check at the first ATM 103 in order to receive funds associated with the check. At step 203, the first ATM 103 may generate a digital check. In generating the digital check, the first ATM 103 may create a digital representation of the check that was previously deposited by the customer. In some instances, the digital representation of the check may be a digital image of the check. Additionally or alternatively, the digital representation of the check may be in a grayscale format. Additionally or alternatively, the digital representation of the check may be created using a bitmapping process. Advantages to the grayscale format and/or bitmapping process may include providing a more detailed representation of the check, as opposed to a bitonal, or black-and-white representation of the check, which may assist in the identification and resolution of anomalies. For example, a black-and-white representation may conceal and/or otherwise obscure certain features of the check that may be used in anomaly detection.

For example, a grayscale format may be used in determining that an individual that is not the customer (i.e., a bad actor) has acquired the customer's check and replaced the customer's name with the bad actor's name in order to deposit the check and receive funds that do not belong to the bad actor. Additionally or alternatively, a bitmapping process may be used to determine that a copy of the customer's check has been created based on a difference between a scaling factor associated with the check and the copy of the check.

At step 204, the first ATM 103 may establish a connection with the anomaly resolution platform 102. For example, the first ATM 103 may establish a first wireless data connection with the anomaly resolution platform 102 to link the first ATM 103 to the anomaly resolution platform 102 (e.g., in preparation for sending a digital check). In some instances, the first ATM 103 may identify whether or not a connection is already established with the anomaly platform 102. If a connection is already established with the anomaly resolution platform 102, the first ATM 103 might not re-establish the connection. If a connection is not already established with the anomaly resolution platform 102, the first ATM 103 may establish the first wireless data connection as described herein.

Referring to FIG. 2B, at step 205, the first ATM 103 may send the digital check (e.g., that corresponds to the check that was received at step 202) to the anomaly resolution platform 102. In some instances, the digital check may be sent before funds associated with the digital check are deposited. For example, the first ATM 103 may send the digital check via the communication interface 113 and while the first wireless data connection is established. At step 206, the anomaly resolution platform 102 may receive the digital check. For example, the anomaly resolution platform 102 may receive the digital check via the communication interface 113 and while the first wireless data connection is established.

At step 207, the anomaly resolution platform 102 may extract parameters from the digital check that was received in step 206. For example, the parameters may include information about the check, such as the name of the customer associated with the check, an account number and/or routing number associated with the check, an address corresponding to the customer's address, an insignia and/or logo associated with the check, a check number associated with the check, a dollar amount associated with the check, and/or the like. In some instances, the parameters may include information that is not on the check, that may be chosen by a financial institution, which may identify the check, such as a bank code that represents the financial institution issuing the check. In some instances, parameters similar to the parameters associated with a check may be created (e.g., parameters associated with a different financial instrument, such as a treasury bill, bond, and the like).

At step 208, the anomaly resolution platform 102 may decode the parameters associated with the digital check. For example, the parameters may have been previously encoded on the check before the first ATM 103 creates the digital representation of the check. In some instances, the parameters may be encoded in a data matrix. For example, in generating the data matrix, the anomaly resolution platform 102 may create a data matrix that may be a two-dimensional code consisting of black and white cells or dots arranged in either a square or rectangular pattern. In some instances, the data matrix may be physically located on the check, such as the top-right corner of the check. In some instances, in creating the digital representation of the check, the first ATM 103 may scan the data matrix after the customer has deposited the check.

In some instances, in generating the data matrix, the anomaly resolution platform 102 may encode the data matrix with a set of parameters based on a predetermined set of rules that may be determined by the financial institution issuing the check. Additionally or alternatively, in generating the data matrix, the anomaly resolution platform 102 may encode the parameters in the data matrix dynamically based on a set of rules, such as a rule of choosing a combination of parameters based on a particular customer depositing the check, a rule of a length of time to use the combination of parameters in the data matrix before changing the combination of parameters, a rule of determining a frequency at which the parameters may change, a rule of configuring a random number generator to output a random number corresponding to a combination of parameters, and/or the like.

For example, a rule may include using a combination of parameters including the name of the customer associated with the check, the account and routing numbers associated with the check, a bank code associated with the financial institution, for a period of time of 3 months. Additionally or alternatively, after 3 months, a second rule may use the above combination of parameters and may also include an address corresponding to the customer's address. Additionally or alternatively, a third rule may include using a random number generator to determine that 5 parameters may be encoded into the data matrix. Additionally or alternatively, any combination of parameters may be used without departing from the scope of the disclosure.

In some instances, the data matrix may be encrypted in order to provide a higher level of security. In some instances, in generating the data matrix, the anomaly resolution platform 102 may create a hash of the encoded parameters, and may place a portion of the hash into the data matrix, rather than the encoded parameters, in order to provide an enhanced level of security associated with the data matrix. In decoding the data matrix, the anomaly resolution platform 102 may also decrypt the data matrix that was previously encrypted.

In some instances, the data matrix may be generated by and stored on a different device (e.g., an enterprise server different from anomaly resolution platform 102, or the like). Additionally or alternatively, the rules, which may be used to decode and/or decrypt the data matrix, may be sent by the different device to the anomaly resolution platform 102.

At step 209, the anomaly resolution platform 102 may execute a parameter comparison. In some instances, the anomaly resolution platform 102 may initialize executable instructions to execute the parameter comparison. For example, the anomaly resolution platform 102 may compare values of the parameters to corresponding expected values of parameters (e.g., comparing the name parameter to the expected name parameter, the account number parameter to the expected account number parameter, the address parameter to the expected address parameter, and/or the like), in order to identify anomalies associated with the check. If one or more anomalies are identified, the anomaly resolution platform 102 may proceed to step 212, as discussed in further detail below. In executing the parameter comparison and identifying one or more anomalies, the anomaly resolution platform 102 may minimize the amount of computing resources used in the identification and resolution of anomalies associated with the check. For example, by applying a direct parameter comparison as a first layer of anomaly identification, use of the herein described anomaly resolution model (which may, e.g., consume more processing resources), may be avoided. If, however, no anomalies are identified, the anomaly resolution platform may proceed to step 210.

Referring to FIG. 2C, at step 210, the anomaly resolution platform 102 may input the parameters into the anomaly resolution model. The anomaly resolution model may be trained (e.g., as described above with regard to step 201) using a record of previous customer interactions at any ATM (such as the first ATM 103 and/or second ATM 104), locations of deposited checks, amounts of the deposited checks, previously detected anomalies, remediation actions, and/or the like.

At step 211, the anomaly resolution platform 102 may execute a program in memory 112, such as from machine learning engine 112c, to perform a validation analysis using the anomaly resolution model. In performing the validation analysis, the anomaly resolution platform 102 may identify an anomaly associated with the check. In some instances, the anomaly resolution platform 102 may identify more than one anomaly. In some instances, the anomaly resolution model may identify an anomaly using a record of a customer's previous financial transactions, such as the location of previous transactions, the frequency of previous transactions, the dollar amount of previous transactions, and/or the like. For example, the anomaly resolution model may identify an anomaly when a check is received at an ATM in a geographic region in which the customer has previously never deposited a check (e.g., the customer's previous deposits occurred at ATMs in North Carolina and a check has been received at an ATM in California). Additionally or alternatively, the anomaly resolution model may identify an anomaly when a frequency of checks that exceeds a predetermined threshold, associated with a customer's account, are received at multiple ATMs, which may indicate a bad actor is attempting to access funds associated with the customer's account. Additionally or alternatively, the anomaly resolution model may identify an anomaly when a check has been received at an ATM and the dollar amount associated with the check is greater than an account balance associated with the customer's account.

In doing so, the anomaly resolution model may identify anomalies using a record of previous financial transactions, and/or financial transactions that have occurred on ATMs across a broad range of geographical regions. This provides the technical benefit of allowing the anomaly resolution model to identify anomalies using a broad range of financial activity and information rather than being limited to a single ATM and a single customer.

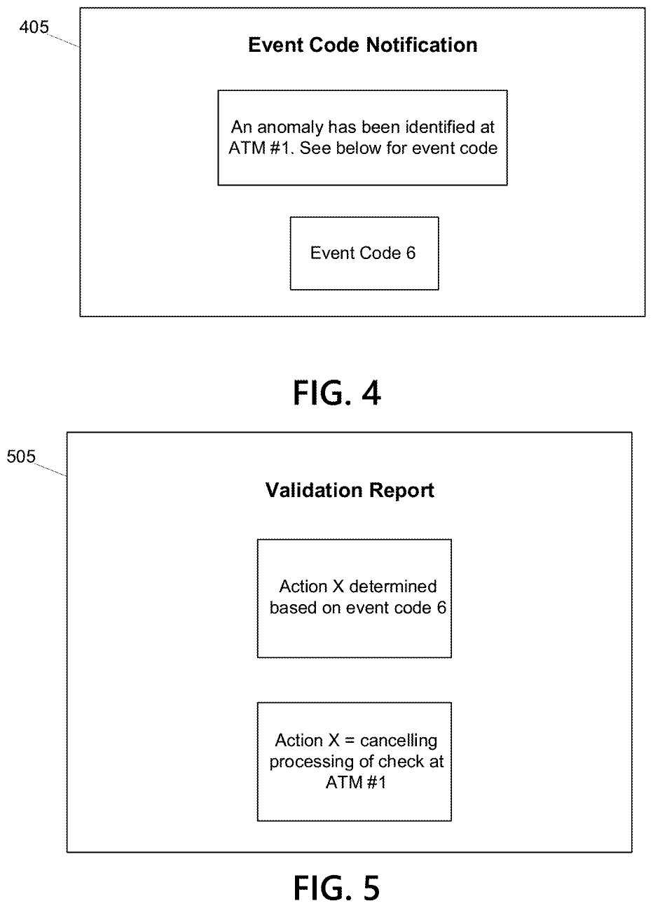

At step 212, the anomaly resolution platform 102 may output an event code, similar to graphical user interface 405, which is illustrated in FIG. 4. In generating the event code, the anomaly resolution platform 102 may output an event code that corresponds to a previously identified anomaly. In some instances, the event code may be determined based on matching the anomaly identified at step 211 to a category of anomaly types (e.g., an anomaly based on a check that has been received at an ATM in a geographic region that a customer has previously never using to deposit a check). In some instances, the event code may be a numerical value. Additionally or alternatively, the numerical value may be categorized in relation to a predetermined threshold range that may be a range of numerical values (e.g., a threshold range of 1-10). In some instances, the threshold range may be stored in memory 112. In some instances, the threshold range may be further delineated to multiple threshold levels based on levels of severity and/or priority associated with the anomaly and the event code. In some instances, the numerical value of the event code may be used to determine an action or multiple actions based on where the numerical value falls in the threshold range. In some instances, the threshold range may be predetermined. In some instances, the threshold range may be dynamically configured.

For example, an event code with a numerical value of 1 may fall within a first threshold that corresponds to an action of causing an ATM (such as the first ATM 103) to be in a state of alert for future potential anomalies. For example, a state of alert may cause the ATM to decrease a level of error tolerance associated with the processing of checks at the ATM. Additionally or alternatively, a state of alert may cause the ATM to increase a level of sensitivity associated with the processing of checks at the ATM.

Additionally or alternatively, an event code with a numerical value of 2 may be determined to be greater than the first threshold but less than a second threshold that is higher than the first threshold, which may correspond to an action of recording a video feed associated with the ATM for a period of time, and/or other actions. Additionally or alternatively, an event code with a numerical value of 4 may be determined to be greater than the second threshold but less than a third threshold that is higher than the second threshold, which may correspond to an action of pausing an ability to use a pin code associated with an account that is associated with the check, and/or other actions. Additionally or alternatively, an event code with a numerical value of 5 may be determined to be greater than the third threshold but less than a fourth threshold that is higher than the third threshold, which may correspond to an action of placing a hold on processing the check at the ATM, and/or other actions. Additionally or alternatively, an event code with a numerical value of 6 may be determined to be greater than the fourth threshold but less than a fifth threshold that is higher than the fourth threshold, which may correspond to an action of cancelling processing of the check at the ATM, and/or other actions. Additionally or alternatively, an event code with a numerical value of 8 may be determined to be greater than the fifth threshold but less than a sixth threshold that is higher than the fifth threshold, which may correspond to an action of shutting down processing of future checks at the ATM for a period of time, and/or other actions. Additionally or alternatively, an event code with a numerical value of 10 may be determined to be greater than the sixth threshold but less than a seventh threshold that is higher than the sixth threshold, which may correspond to an action of shutting down processing of future check for a fleet of ATMs in a geographic region associated with the ATM, and/or other actions. In this manner, the severity of the action may increase as the value of the event code increases. In some instances, the thresholds and/or threshold ranges may differ from the above illustration, and there may be different correlations between the thresholds and the selected actions without departing from the scope of the disclosure.

In some instances, if the anomaly resolution platform 102 does not identify an anomaly, the anomaly resolution platform 102 may send commands, that when received by the first ATM 103, cause the first ATM 103 to process the check that was deposited by the customer and not take any of the previously mentioned actions or output an event code. Additionally or alternatively, if the anomaly resolution platform does not identify an anomaly, the anomaly resolution platform may proceed to step 222. Otherwise, the anomaly resolution platform 102 may proceed to step 213.

At step 213, the anomaly resolution platform 102 may generate a validation report. In generating the validation report, the anomaly resolution platform 102 may output a validation report that may comprise an anomaly, an event code associated with the anomaly, and an action to resolve the anomaly corresponding to the event code, similar to graphical user interface 505, which is illustrated in FIG. 5. In some instances, the anomaly resolution model may generate the validation report.

Referring to FIG. 2D, at step 214, the anomaly resolution platform 102 may establish a connection with enterprise user device 105. For example, the anomaly resolution platform 102 may establish a second wireless data connection with the enterprise user device 105 to link the anomaly resolution platform 102 to the enterprise user device 105 (e.g., in preparation for sending the validation report). In some instances, the anomaly resolution platform 102 may identify whether or not a connection is established with the enterprise user device 105. If a connection is already established with the enterprise user device 105, the anomaly resolution platform 102 might not re-establish the connection. If a connection is not yet with the enterprise user device 105, the anomaly resolution platform 102 may establish the second wireless data connection as described herein.

At step 215, the anomaly resolution platform 102 may send the validation report to the enterprise user device 105. For example, the anomaly resolution platform 102 may send the validation report to the enterprise user device 105 while the second wireless data connection is established.

At step 216, the enterprise user device 105 may receive the validation report. For example, the enterprise user device 105 may receive the validation report via the communication interface 113 and while the second wireless data connection is established. Additionally or alternatively, the enterprise user device 105 may receive commands, that when received, cause the enterprise user device 105 to display the validation report.

At step 217, based on or in response to the commands sent at step 216, the enterprise user device 105 may display the validation report. In some instances, the enterprise user device 105 may display a graphical user interface similar to graphical user interface 505, which is illustrated in FIG. 5.

At step 218, the anomaly resolution platform 102 may establish a connection with the second ATM 104. For example, the anomaly resolution platform 102 may establish a third wireless data connection with the second ATM 104 to link the anomaly resolution platform 102 to the second ATM 104. In some instances, the anomaly resolution platform 102 may identify whether or not a connection is established with the second ATM 104. If a connection is already established with the second ATM 104, the anomaly resolution platform 102 might not re-establish the connection. If a connection is not yet with the second ATM 104, the anomaly resolution platform 102 may establish the third wireless data connection as described herein.

Referring to FIG. 2E, at step 219, the anomaly resolution platform 102 may send commands to either of the first ATM 103 and/or the second ATM 104. For example, the anomaly resolution platform 102 may send the commands to either of the first ATM 103 and/or the second ATM 104 while the second and/or third wireless data connections are established. In generating the commands, the anomaly resolution platform 102 may generate commands that, when executed by either of the first ATM 103 and/or the second ATM 104, cause the first ATM 103 and/or the second ATM 104 to execute one or more actions, such as, for example, an action of cancelling processing of the check that was deposited at the first ATM 103, an action of cancelling processing of checks at the second ATM 104 for a period of time, and/or the like. In some instances, the first ATM 103 and the second ATM 104 may execute the same action. In some instances, the first ATM 103 and the second ATM 104 may execute different actions. In some instances, the second ATM 104 may execute an action based on the action executed by the first ATM 103. In doing so, anomaly identification performed at a given ATM may be used to inform actions to be performed at a different ATM (e.g., thereby increasing security of the other ATM based on the anomaly identification at the original ATM).

At step 220, either of the first ATM 103 and/or the second ATM 104 may receive the commands from the anomaly resolution platform 102. For example, the first ATM 103 and/or the second ATM 104 may receive the commands while the second and/or third wireless data connections are established.

At step 221, either or both of the first ATM 103 and/or the second ATM 104 may execute the commands. In executing the commands, the anomaly resolution platform 102 may direct the first ATM 103 and/or the second ATM 104 to take one or more actions based on, for example, a previously identified anomaly or anomalies. For example, if recording a video feed at an ATM for a period of time has been determined as an action, this action may increase the security at the ATM and may be used to determine that a bad actor has used the ATM and not the customer. Additionally or alternatively, if pausing an ability to use a pin code associated with an account has been determined as an action, this action may increase the security of any ATM that a bad actor may attempt to access in order to receive funds that do not belong to the bad actor. In performing any of the actions identified in step 213, a level of security at an ATM or fleet of ATMs may be increased.

In some instances, the anomaly resolution platform 102 may automatically direct the first ATM 103 and/or the second ATM 104 to execute the actions in real-time. In some instances, a user of the enterprise user device 105 may review the validation report and approve the execution of the actions by sending commands to the first ATM 103 and/or the second ATM 104, that when received, cause the first ATM 103 and/or the second ATM 104 to execute the previously determined actions.

At step 222, the anomaly resolution platform 102 may update the anomaly resolution model. For example, the anomaly resolution model may be updated based on the outputs of steps 209, 210, 211, 212, 213, and/or feedback received from the first ATM 103, the second ATM 104, and/or enterprise user device 105. In doing so, the anomaly resolution platform 102 may dynamically and continuously update and/or otherwise refine the anomaly resolution model so as to increase accuracy of the anomaly resolution model over time. In increasing the accuracy of the anomaly resolution model, the anomaly resolution model may increase the likelihood of identifying anomalies in the future, and increase the effectiveness of resolving the anomalies using the actions corresponding to the anomalies.

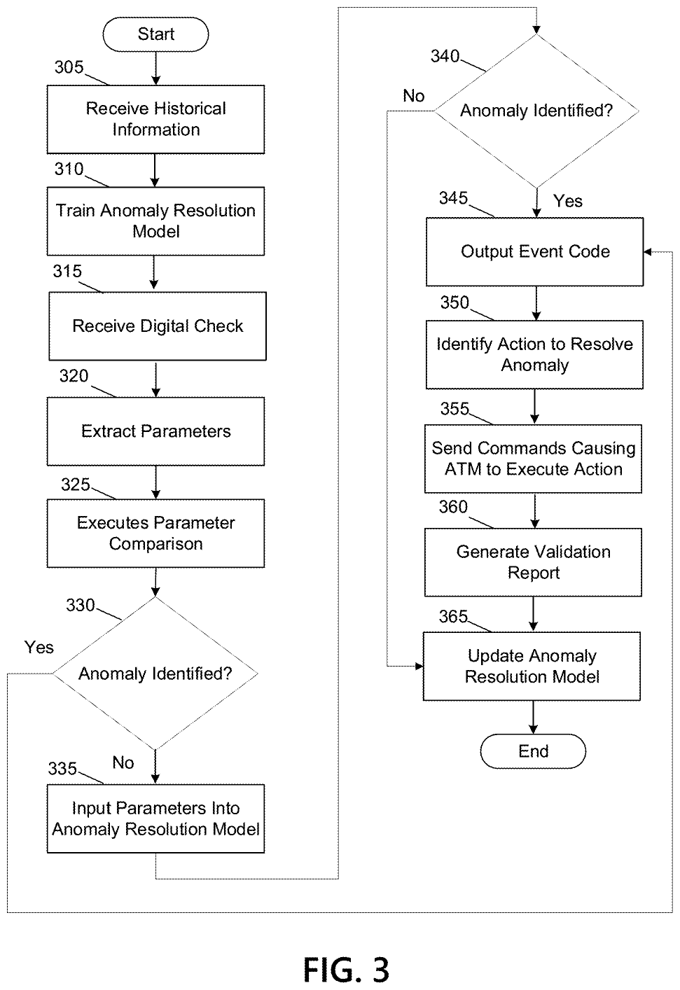

FIG. 3 depicts an illustrative method for identifying and resolving anomalies when an ATM processes a check in accordance with one or more aspects described herein. At step 305, a computing platform having at least one processor, a communication interface, and memory may receive historical information. At step 310, the computing platform may use the historical information to train an anomaly resolution model. At step 315, the computing platform may receive a digital check. At step 320, the computing platform may extract parameters associated with the digital check. At step 325, the computing platform may execute a parameter comparison. If an anomaly is identified, the computing platform may proceed to step 345. If an anomaly has not been identified, the computing platform may proceed to step 335. At step 335, the computing platform may input the parameters into the anomaly resolution model. If an anomaly is identified, the computing platform may proceed to step 345. If an anomaly has not been identified, the computing platform may proceed to step 365. At step 345, the computing platform may output an event code. At step 350, the computing platform may identify an action to resolve the anomaly. At step 355, the computing platform may send commands causing the ATM to execute the action. At step 360, the computing platform may generate a validation report. At step 365, the computing platform may update the anomaly resolution model.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
train, based on historical information, an anomaly resolution model, wherein training the anomaly resolution model configures the anomaly resolution model to generate, based on the historical information, a validation report comprising:
an anomaly;
an event code associated with the anomaly; and
an action to resolve the anomaly based on the event code;
receive, from an automated teller machine (ATM), a digital check that is a digital representation of a check that has been received by the ATM;
extract, using the computing platform, first parameters associated with the digital check;
input the first parameters into the anomaly resolution model, wherein inputting the parameters causes the anomaly resolution model to:
output a first anomaly and a first event code associated with the first anomaly;
determine, based on the first anomaly and the first event code, a first action to resolve the first anomaly;
generate a first validation report, wherein the first validation report comprises the first anomaly, the first event code associated with the first anomaly, and the first action to resolve the first anomaly;
generate, based on the first validation report, one or more commands, that when executed by the ATM, cause the ATM to execute the first action to resolve the first anomaly; and
send, to the ATM, the one or more commands, wherein sending the one or more commands causes the ATM to execute the first action to resolve the first anomaly.

2. The computing platform of claim 1, wherein the memory stores additional computer-readable instructions that, when executed by the at least one processor, cause the computing platform to send, to an enterprise user device, the first validation report and one or more commands directing the enterprise user device to display the first validation report, wherein sending the one or more commands directing the enterprise user device to display the validation report causes the enterprise user device to display the validation report.

3. The computing platform of claim 1, wherein the memory stores additional computer-readable instructions that, when executed by the at least one processor, cause the computing platform to:
receive, from the ATM, a second digital check that is a digital representation of a second check that has been received by the ATM;
extract, using the computing platform, second parameters associated with the second digital check;
output, based on comparing values of the second parameters to expected values of the second parameters, a second anomaly and a second event code associated with the second anomaly;
determine, based on the second anomaly and the second event code, a second action to resolve the second anomaly;
generate one or more commands, that when executed by the ATM, cause the ATM to execute the second action to resolve the second anomaly; and
send, to the ATM, the one or more commands, wherein sending the one or more commands causes the ATM to execute the second action to resolve the second anomaly.

4. The computing platform of claim 1, wherein the first parameters comprise one or more of: an insignia associated with the check, a name associated with the check, an address associated with the check, an account number associated with the check, a routing number associated with the check, a check number associated with the check, a dollar amount associated with the check, a bank code associated with a financial institution issuing the check.

5. The computing platform of claim 1, wherein a data matrix associated with the check contains an encoded representation of one or more parameters and is dynamically configured based on a set of rules.

6. The computing platform of claim 5, wherein the set of rules comprise one or more of: a first rule of determining a combination of parameters based on a customer depositing the check, a second rule of determining a length of time to use the combination of parameters, a third rule of determining a frequency of changing the combination of parameters, and a fourth rule of configuring a random number generator to output a random number corresponding to the determining the combination of parameters.

7. The computing platform of claim 1, wherein the first event code comprises a numerical value.

8. The computing platform of claim 7, wherein the memory stores additional computer-readable instructions that, when executed by the one or more processors, cause the computing platform to:
compare the numerical value to a threshold; and
based on identifying that the numerical value is greater than or equal to the threshold, selecting, as the first action, one or more of: causing the ATM to be in a state of alert for future potential anomalies, recording a video feed associated with the ATM for a period of time, pausing an ability to use a pin code associated with an account that is associated with the check, placing a hold on processing the check at the ATM, cancelling processing of the check at the ATM, shutting down processing of future checks at the ATM for a period of time, or shutting down processing of future checks for a fleet of ATMs in a geographic region associated with the ATM.

9. The computing platform of claim 8, wherein causing the ATM to be in a state of alert causes the ATM to decrease a level of error tolerance associated with processing the digital check.

10. The computing platform of claim 1, further comprising refining the anomaly resolution model based on:
the check;
the first anomaly;
the first event code associated with the first anomaly; and
the first action to resolve the first anomaly.

11. The computing platform of claim 1, wherein the historical information comprises:
historical checks;
historical anomalies;
historical event codes associated with corresponding historical anomalies;
historical actions that resolved the corresponding historical anomalies; and
historical validation reports.

12. The computing platform of claim 1, wherein the anomaly resolution model comprises one of a locally stored model at a backend server or a cloud based model.

13. The computing platform of claim 1, wherein the ATM automatically executes the first action to resolve the first anomaly in real-time.

14. The computing platform of claim 1, wherein the memory stores additional computer-readable instructions that, when executed by the one or more processors, cause the computing platform to:
generate one or more commands, that when executed by a second ATM, cause the second ATM to execute a second action based on the first action; and
send, to the second ATM, the one or more commands, wherein sending the one or more commands causes the second ATM to execute the second action.

15. The computing platform of claim 1, wherein the digital representation of the check is in a grayscale format.

16. The computing platform of claim 1, where the digital representation of the check is a digital image of the check.

17. A method comprising:
at a computing platform comprising at least one processor, a communication interface, and memory:
training, based on historical information, an anomaly resolution model, wherein training the anomaly resolution model configures the anomaly resolution model to generate, based on the historical information, a validation report comprising:
an anomaly;
an event code associated with the anomaly; and
an action to resolve the anomaly based on the event code;
receiving, from an automated teller machine (ATM), a digital check that is a digital representation of a check that has been received by the ATM;
extracting, using the computing platform, first parameters associated with the digital check;
inputting the first parameters into the anomaly resolution model, wherein inputting the parameters causes the anomaly resolution model to:
output a first anomaly and a first event code associated with the first anomaly;
determine, based on the first anomaly and the first event code, a first action to resolve the first anomaly;
generate a first validation report, wherein the first validation report comprises the first anomaly, the first event code associated with the first anomaly, and the first action to resolve the first anomaly;
generating, based on the first validation report, one or more commands, that when executed by the ATM, cause the ATM to execute the first action to resolve the first anomaly; and
sending, to the ATM, the one or more commands, wherein sending the one or more commands causes the ATM to execute the first action to resolve the first anomaly.

18. The method of claim 17, further comprising sending, to an enterprise user device, the first validation report and one or more commands directing the enterprise user device to display the first validation report, wherein sending the one or more commands directing the enterprise user device to display the validation report causes the enterprise user device to display the validation report.

19. The method of claim 17, further comprising:
receiving, from the ATM, a second digital check that is a digital representation of a second check that has been received by the ATM;
extracting, using the computing platform, second parameters associated with the second digital check;
outputting, based on comparing values of the second parameters to expected values of the second parameters, a second anomaly and a second event code associated with the second anomaly;
generating one or more commands, that when executed by the ATM, cause the ATM to execute a second action to resolve the second anomaly; and
sending, to the ATM, the one or more commands, that when executed by the ATM, cause the ATM to execute the second action to resolve the second anomaly, wherein sending the one or more commands causes the ATM to execute the second action to resolve the second anomaly.

20. One or more non-transitory computer-readable storing instructions that, when executed by a computing platform comprising at least one processor, a communication interface, and memory, cause the computing platform to:
train, based on historical information, an anomaly resolution model, wherein training the anomaly resolution model configures the anomaly resolution model to generate, based on the historical information, a validation report comprising:
an anomaly;
an event code associated with the anomaly; and
an action to resolve the anomaly based on the event code;
receive, from an automated teller machine (ATM), a digital check that is a digital representation of a check that has been received by the ATM;
extract, using the computing platform, first parameters associated with the digital check;
input the first parameters into the anomaly resolution model, wherein inputting the parameters causes the anomaly resolution model to:
output a first anomaly and a first event code associated with the first anomaly;
determine, based on the first anomaly and the first event code, a first action to resolve the first anomaly;
generate a first validation report, wherein the first validation report comprises the first anomaly, the first event code associated with the first anomaly, and the first action to resolve the first anomaly;
generate, based on the first validation report, one or more commands, that when executed by the ATM, cause the ATM to execute the first action to resolve the first anomaly; and
send, to the ATM, the one or more commands, wherein sending the one or more commands causes the ATM to execute the first action to resolve the first anomaly.
